(19) United States
(12) Patent Application Publication
(10) Pub. No.: US 2008/0048019 A1
(43) Pub. Date: Feb. 28, 2008

(54) System for Paying Vendor Goods and Services by Means of Prepaid Buying Tickets

(75) Inventors: Stephane Petit, Herouville Saint Clair (FR); Jerome Laudouar, Caen (FR); Yvan Raffle, Argences (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/663,612

(22) PCT Filed: Sep. 19, 2005
(86) PCT No.: PCT/FR05/02314

§ 371 Date: Jun. 20, 2007

(30) Foreign Application Priority Data
Sep. 24, 2004 (FR) 0410115

(51) Int. Cl. G07F 19/00; G06Q 30/00; G07F 7/02

(52) U.S. Cl. 235/379; 186/37; 194/205

(57) ABSTRACT

A system is provided for paying vendors for their products and services by means of anonymous prepaid purchase tickets issued by a banking institution. The system includes ticket issuing means and ticket generating means associated respectively with first data storage means in which the ticket(s) belonging to each user are stored and second data storage means in which goods bought by means of each ticket are stored and the value of each ticket is updated according to the payments made by means of the tickets. The system also includes a system for managing the value of each ticket according to payments effected and for managing remuneration of vendors, the management system being associated with the second data storage means and supplying information on payments effected to the banking institution for remunerating each vendor.

The invention relates to an installation for paying for goods or services by means of an anonymous prepayment medium with a limit on the amount that may be debited.

Such purchase coupons or tickets may be used to pay vendors for any type of goods or services, either in person, in stores, or remotely to pay for mail-order purchases. However, one particularly beneficial application of the installation according to the invention relates to paying for mail-order purchases via the Internet.

There exist at present various types of services for acquiring goods or services by means of a prepaid purchase ticket.

See for example patent applications FR 2 821 221 and FR 2 805 910, which describe various types of system for paying by means of an anonymous prepaid ticket. Such systems enable a user to acquire a prepaid ticket that can afterwards be used instead of cash to pay various types of vendor.

The applicable legal provisions require that it be possible to identify prepaid goods or services. The same applies to the acquirer of the goods or services, whom it must be possible to identify at the time of the prepayment.

However, the association between the identifier of the prepaid tickets acquired and the identity of the acquirer is not accessible to the prior art systems.

Moreover, in such systems, the prepaid goods or services are not defined in that the purchase ticket, which constitutes the prepaid article, is not attached to any goods or services.

The object of the invention is to provide an installation for paying vendors for goods or services by means of anonymous prepaid purchase tickets enabling recovery of indications relating to the identity of the acquirer, at the same time as preserving the anonymous character of the purchase vis-à-vis the vendors.

The invention therefore provides an installation for paying vendors for goods or services by means of anonymous prepaid purchase tickets issued by a banking institution. The installation includes ticket issuing means and ticket generation means respectively associated with first data storage means in which each user's ticket(s) are stored and second data storage means in which purchases effected by means of each ticket are stored and in which the value of each ticket is updated as a function of payments effected by means of the tickets, the installation further including a management system for managing the value of each ticket as a function of the payments effected and for managing remuneration of vendors, the management system being associated with the second data storage means and supplying the banking institution with information relating to the payments effected in order to remunerate each vendor.

Accordingly, the identification of the holder of each ticket in the data storage means enables the acquirers of the purchase tickets to be identified. Similarly, the storage of the purchases in the accounting database provides information relating to the purchases effected by means of the tickets.

According to another feature of the invention, the ticket issuing means form part of the banking institution. Moreover, the management system constitutes an element separate from said ticket issuing means and so the first data storage means in which each user's ticket(s) are stored are inaccessible from the management system.

According to another feature of the invention, the ticket issuing means are associated with user authentication and identification means for authorizing issuing of tickets after identification and authentication of the users.

In one embodiment, the installation further includes a set of automated terminals accessible by users to purchase tickets previously made available to the bank institution by the management system, the authentication and identification means being integrated into each terminal.

In one embodiment, the management system includes means for sending to the banking institution an indication of each purchase effected by means of each ticket.

The invention also provides a system for issuing prepaid purchase tickets for an installation as defined above for paying for goods or services, characterized in that it includes data storage means in which each user's ticket(s) and a list of purchases effected by means of each ticket are stored.

According to another aspect, the invention provides a system for generating prepaid purchase tickets for an installation as defined above for paying for goods or services, characterized in that it includes data storage means in which purchases effected by means of each ticket are stored and in which the value of each ticket is updated as a function of the purchases effected.

The invention further provides a computer program stored on a data storage medium, characterized in that it includes a first set of instruction codes adapted to assign one or more prepaid purchase tickets to each user when it is executed in a ticket issuing system as defined above.

Finally, in a fifth aspect, the invention provides a computer program stored on a data storage medium, characterized in that it includes a first set of instruction codes adapted to generate purchase tickets each having a predetermined issue value and a second set of instruction codes adapted to update the value of each ticket as a function of purchases effected when it is executed in a ticket generation system as defined above.

The data medium may be a hardware storage medium, for example a CD-ROM, a magnetic diskette or hard disk, or a transmissible medium such as an electrical, optical or radio signal.

Other objects, features and advantages of the invention become apparent on reading the following description, given by way of non-limiting example only and with reference to the appended drawings, in which:

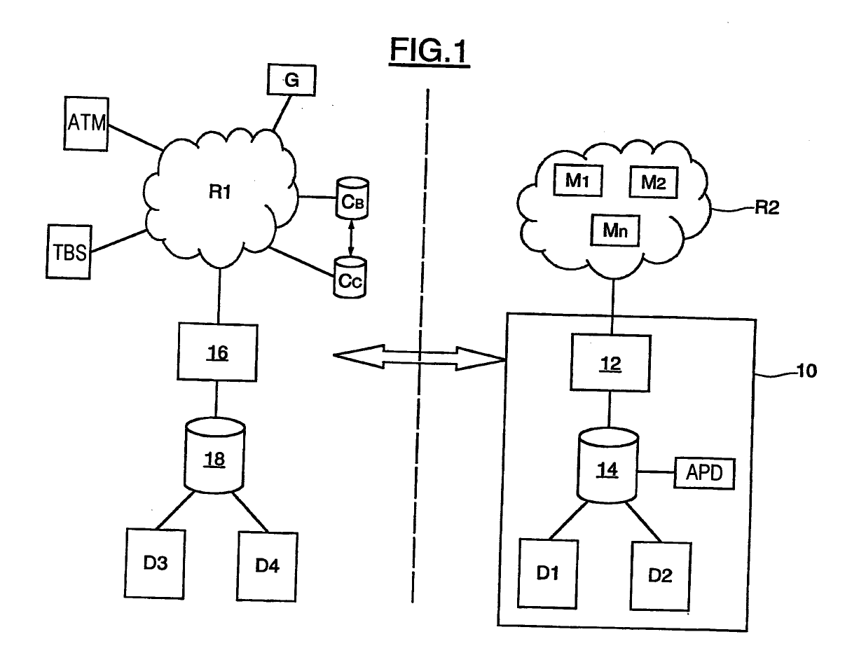

FIG. 1 is a block diagram showing the general architecture of an installation in accordance with the invention for paying for goods or services;

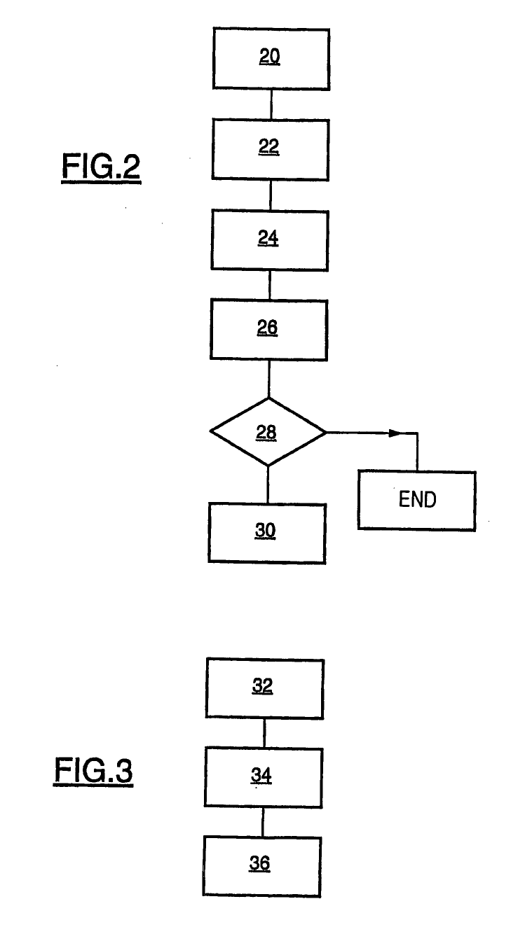

FIG. 2 is a flowchart showing the acquisition of purchase tickets by users; and

FIG. 3 is a flowchart showing a stage of paying for goods and reimbursing a vendor by means of a purchase ticket according to the invention.

An installation according to the invention for paying vendors for goods or services is described with reference to FIG. 1.

That installation is intended to enable a user to acquire one or more prepaid purchase tickets from a banking institution belonging a network R1 of banking establishments, and to use the prepaid ticket(s) anonymously to buy from vendors M1, . . . , Mₙ of a network R2 of vendors.

The vendors M1, M2, . . . , Mₙ of the network R2 to which the customer has access may be commercial establishments of various kinds having either retail outlets in which customers can acquire goods or Internet sites for mail-order purchase of goods or services.

With regard to the network of banks, it is considered in the remainder of the description that this network consists of a single banking establishment represented diagrammatically by a network of teller positions G and automated teller machines ATM, a first database C_{C} grouping together the customer accounts of the users, and a second database C_{B} constituting the overall account of the bank, i.e. a buffer account through which streams of financial transactions coming from customer accounts pass in transit.

As seen in FIG. 1, the service in accordance with the invention for paying for goods or services by means of prepaid purchase tickets uses a payment third party 10, i.e. a party having the status of a financial establishment accredited by banks and vendors and linked contractually to them. This payment third party also constitutes the contact used by customers for effecting transactions on-line.

This payment third party 10 essentially includes a management system 12, for example a computer appropriately programmed to generate prepaid purchase tickets with a predetermined initial or issue value, to manage the outstanding value of each ticket issued on demand by the banking institutions as a function of the payments effected, and to manage the reimbursement of vendors.

This system 12 is associated with a database 14 which stores a first data set D1 corresponding to the outstanding value of each ticket issued and a data set D2 relating to operations effected by means of each ticket and to payments to be made to vendors. The term “outstanding value of a ticket” means its initial or issue value less the value of purchases.

Clearly, the data sets D1 and D2 may be stored in the same database 14 or in respective databases. Note, however, that the first data set D1 takes the form, for example, of a set of numbers of identifiers of tickets which are associated with respective outstanding values that are regularly updated by the management system as a function of the purchases effected. Similarly, the data set D2 takes the form of a list of operations effected, each associated with a ticket number, in the form of an account of payments due (APD). This account APD includes the following information: purchase ticket number, amount for purchase due to vendor, amount to be paid by vendor to payment third party for that ticket, issue number, identification of bank that requested and received purchase ticket, issue date, and number of contract between vendor and payment third party.

Moreover, the installation includes, on the bank network R1 side, a system 16 for issuing tickets, also consisting of a computer appropriately programmed, firstly, to issue tickets purchased to users, subject to debiting the account C_{C} of the user and crediting the global account C_{B} of the bank, and to update the outstanding value of each ticket as a function of the purchases effected and, secondly, to remunerate vendors through the intermediary of the payment third party.

As seen in FIG. 1, the ticket issuing system 16 is associated with a purchase database 18 that groups together a data set D3 in which each customer is assigned one or more tickets and a second data set D4 grouping together all operations effected on each ticket.

The data sets D3 and D4 may be grouped together in a single database 18, as shown in FIG. 1, or stored in respective databases.

Clearly, the payment third party, that generates the tickets and manages remuneration of vendors and purchases effected by means of the tickets, is situated on the vendor's side. It has no information relating to the identity of the holders of the tickets. That information is available only in the database 18.

The management system 12 and the ticket issuing system 16 communicate by any appropriate means, for example a computer network.

Note, however, that they constitute structurally separate units, the ticket issuing system 16 associated with the bank network communicating with the payment third party 10 only to exchange information relating to the outstanding value of each ticket, to recover a list of operations effected on each ticket, and to remunerate vendors.

In other words, as indicated above, the payment third party 10 receives no information relating to the identity of customers holding purchase tickets. The purchase tickets also remain anonymous on the vendor network R2 side.

The installation that is described above operates in the following manner.

The procedure for purchasing and using tickets is described first with reference to FIG. 2.

That procedure begins with a first stage during which the tickets are generated. During a first step 20, the management system 12 of the payment third party 10 generates ticket numbers and assigns an issue value to each ticket generated. This information is stored in the database 14. During the next step 22, this information is sent to the system 16 of the banking institution in the form of a list of ticket numbers associated with respective issue values. This information is stored in the purchase database 18.

Following this stage of generation of purchase tickets, if a user wishes to acquire one or more tickets, then the user contacts the banking institution in order to make a purchase. Clearly, that purchase may be effected by any appropriate means, by going to a teller position G in the bank, using the automated teller machines (ATM) of the bank network, using a telebanking system (TBS), using a dynamic virtual bank card system, etc.

Note, however, that all means used by the banking institutions to sell purchase tickets employ a step of identifying and authenticating the customer that may use an identifier and a password (step 24). However, if the tickets are purchased by means of an ATM and a bank card, for example, the purchaser is authenticated and identified by authentication and identification means linked to the processing procedure of the ATM, i.e. generally by generation of an authentication and identification certificate following entry of the PIN linked to the bank card.

Following authentication, for the purchase as such of one or more tickets, the bank account C_{C} of the customer is debited by an amount corresponding to the value of the ticket purchased, or to the sum of the values of the tickets purchased, and the global bank account C_{B} of the bank is credited with a corresponding amount. The ticket(s) are then issued.

When the user wishes to use a ticket, either in person at a retail outlet of a vendor M1, M2, . . . , Mₙ or remotely, the number of the user's ticket is entered (step 26). During the next step 28, the payment third party checks that the ticket is active. For this purpose, it consults the database 14 in order to obtain the value associated with the ticket and to check that the ticket is currently valid. After checking the ticket, the management system 12 sends a purchase acknowledgement to the vendor M1, M2, . . . , Mₙ (step 30). During this step, the value of the ticket is reduced by an amount corresponding to that of the purchase effected and the purchase is logged in the database 14. In contrast, if during the preceding step 28 the management system 12 detects that the ticket is no longer valid or that its amount is insufficient, the purchase is not authorized and the procedure terminates. The vendor is then informed of the situation.

Note, however, that a customer retains the option of using a plurality of prepaid tickets to purchase one item, in order for residual amounts not to remain on tickets, which could happen if the outstanding value of a ticket were less than the value of an item to be acquired. This option is reflected by successively entering the numbers of the tickets used or by writing the numbers of the tickets used, an identifier, and a password into a file forming a ticket wallet. When purchasing goods with a ticket wallet, only the identifier and the passwords are used to purchase an article.

The procedure for remunerating vendors is described below with reference to FIG. 3.

This procedure begins with a first step 32 during which operations effected by means of each ticket are sent to the system 16. This information may be sent either periodically, in the form of a set of operations carried out for each ticket, or at the time of each operation. After reception of this information, the system 16 updates the data set D3 stored in the purchase database 18 to update the outstanding value of each ticket. During the next step 34, the vendors are remunerated. This stage corresponds to debiting the global bank account C_{B} of the bank and crediting the vendors.

If the payment third party 10 has the status of a financial establishment, it receives from the bank the funds corresponding to the purchases effected and then assumes responsibility for remunerating vendors in accordance with information contained in the payments due account (APD) stored in the database 14. The management system 12 then updates this account APD as a function of the payments due (step 36).

After confirmation of the shipping of each product or the delivery of each service, the management system 12 feeds the account of payments due (APD).

Clearly, the above-described invention, which uses a purchases database in which the identity of each user of purchase tickets is stored, enables the identity of a purchaser to be discovered if required, although the purchaser remains anonymous at the time of the purchase. It is furthermore possible to determine the nature of the purchase effected.

Note that updating the value of the tickets at the levels of the payment third party 10 and the system 16 provides a two-tier check that prevents a purchase being effected by means of a ticket having insufficient credit.

Note finally that the above-described invention may also be applied generally to transferring goods or services from a first holder to a second holder after transferring data from the second holder to the first holder.

The data held by each second holder is stored on a medium, in this instance a ticket, issued by medium issuing means and generated by media generation means that are respectively associated with first data storage means in which the medium that each user holds is stored and second data storage means in which the exchanges effected by each medium are stored and in which the data is updated.

Furthermore, a management system associated with the second storage means manages the data on each medium as a function of the exchanges effected and transfers the data to the first holder.

1. An installation for paying vendors for goods or services by means of anonymous prepaid purchase tickets issued by a banking institution, the installation comprising:
a ticket issuing means,
a ticket generation means;
a first data storage means associated with the ticket issuing means, the first data storage means storing data regarding each user's tickets(s);
second data storage means associated with the ticket generation means, the second data storage means storing data regarding purchases effected by use of each ticket, and updating the value of each ticket as a function of payments effected by use of the tickets; and a management system for managing the value of each ticket as a function of the payments effected and for managing remuneration of vendors, the management system being associated with the second data storage means and supplying the banking institution with information relating to the payments effected in order to remunerate each vendor.

2. The installation according to claim 1, wherein the ticket issuing means is a part of the banking institution and the management system constitutes an element separate from said ticket issuing means so that the first data storage means in which each user's ticket(s) are stored are inaccessible from the management system.

3. The installation according to claim 1, wherein the ticket issuing means are associated with user authentication and identification means for authorizing issuing of tickets after identification and authentication of users.

4. The installation according to claim 3, further comprising a set of automated terminals (ATM) accessible by users to purchase tickets previously made available to the banking institution by the management system, the authentication and identification means being integrated into each terminal.

5. The installation according to claim 1, wherein the management system includes means for sending the banking institution an indication of each purchase effected by means of each ticket in order to remunerate vendors.

6. A system for issuing prepaid purchase tickets, the system including an installation according to claim 1 for paying for goods or services, wherein the first data storage means stores data regarding each user's ticket(s) and a list of purchases effected by use of each ticket.

7. A system for generating prepaid purchase tickets, the system including an installation according to claim 1 for paying for goods or services, wherein the second data storage means stores data regarding purchases effected by use of each ticket, and updates the value of each ticket as a function of the purchases effected.

8. A computer program stored on a data storage medium, characterized in that it includes a first set of instruction codes adapted to assign one or more prepaid purchase tickets to each user when it is executed in a ticket issuing system according to claim 6.

9. A computer program stored on a data storage medium, characterized in that it includes a first set of instruction codes adapted to generate purchase tickets each having a predetermined issue value and a second set of instruction codes adapted to update the value of each ticket as a function of purchases effected when it is executed in a ticket generation system according to claim 7.
